(19) United States
(12) Patent Application Publication
(10) Pub. No.: US 2020/0359843 A1
(43) Pub. Date: Nov. 19, 2020

(54) FOOD PROCESSOR

(71) Applicants: Xiushan Ye, Guangzhou (CN); GUANGZHOU SHENGWEI ELECTRIC MANUFACTURING CO., LTD., Guangzhou (CN)

(72) Inventor: Xiushan Ye, Guangzhou (CN)

(21) Appl. No.: 16/985,253

(22) Filed: Aug. 5, 2020

Related U.S. Application Data
(63) Continuation of application No. PCT/CN2018/084064, filed on Apr. 23, 2018.

(30) Foreign Application Priority Data
Feb. 6, 2018 (CN) 201810117397.0

(51) Int. Cl. A47J 43/07; A47J 43/046; G01G 19/52

(52) U.S. Cl. CPC A47J 43/0716; A47J 43/046; A47J 2043/0733; A47J 43/0766; G01G 19/52; A47J 43/0727

(57) ABSTRACT

The present disclosure provides a food processor including an electronic scale (2) and a machine (1) placed on the electronic scale (2). The electronic scale (2) includes an electronic scale printed circuit board (3), an insulating plate (4), a sensor fixing plate (5), four weight sensors (6) fixed on the sensor fixing plate (5), and a sensor fixing base (7) configured to be placed on a working platform surface for the food processor. A ground wire (8) is connected to the sensor fixing plate (5) to ground outer shells of the four weight sensors (6) simultaneously, so that interference introduced from the machine (1) or from outside is filtered out through the ground wire (8) when the electronic scale (2) is in operation.

### CROSS-REFERENCE TO RELATED APPLICATIONS

The present application is a continuation-application of International (PCT) Patent Application No. PCT/CN2018/084064 filed on Apr. 23, 2018, which claims priority of Chinese Patent Application No. 201810117397.0, filed on Feb. 6, 2018 in the National Intellectual Property Administration of China, the contents of all of which are hereby incorporated by reference.

### TECHNICAL FIELD

The present disclosure relates to a food processor, and more particularly, to a food processor with an electronic scale connected to a ground wire and a machine.

### BACKGROUND

Conventionally, an electronic scale of a food processor, during operation, is usually subjected to interference introduced from a machine or from outside, such that the electronic scale offers inaccurate and unstable measurement results. Additionally, since the machine placed on the electronic scale may be overturned during operation due to various factors including inappropriate placement and external impact, it is easy to damage the machine and endanger the user's safety.

### SUMMARY

An aspect of the present disclosure provides a food processor, which includes an electronic scale and a machine placed on the electronic scale. The electronic scale includes an electronic scale printed circuit board, an insulating plate, a sensor fixing plate, four weight sensors fixed on the sensor fixing plate, and a sensor fixing base configured to be placed on a working platform surface for the food processor. A ground wire is connected to the sensor fixing plate to ground outer shells of the four weight sensors simultaneously, so that interference introduced from the machine or from outside is filtered out through the ground wire when the electronic scale is in operation.

### BRIEF DESCRIPTION OF THE DRAWINGS

The present disclosure can be described in more detail through embodiments with reference to the accompanying drawings, wherein the accompanying drawings are not drawn to scale.

FIG. 1 is an exploded view of a food processor.

FIG. 2 is a partially exploded view of the food processor.

FIG. 3 is an enlarged view of a weight sensor of an electronic scale shown in FIG. 1.

### DETAILED DESCRIPTION

The present disclosure will be described in more detail below in conjunction with specific embodiments, Those skilled in the art should understand that, these descriptions only list some specific embodiments of the present disclosure and do not limit the present disclosure and its protection scope.

In addition, when introducing elements of various embodiments of the present disclosure, the articles “a”, “an”, “the”, and “said” are intended to mean that there are one or more of the elements. The terms “including”, “containing” and “having” are intended to be inclusive and mean that there may be additional elements other than the listed elements.

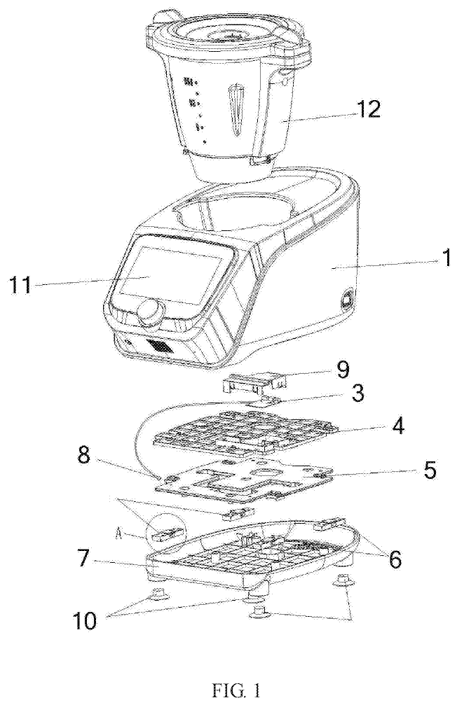

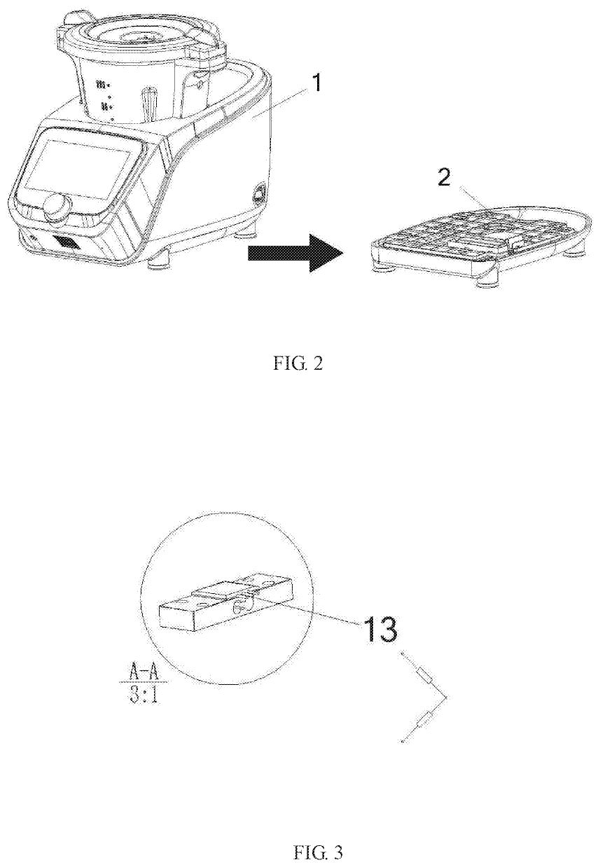

As shown in FIGS. 1 and 2, a food processor includes an electronic scale 2 and a machine 1 detachably placed on the electronic scale 2. The electronic scale 2 may include an electronic scale printed circuit board (PCB) 3, an insulating plate 4, a sensor fixing plate 5, four weight sensors 6 fixed on the sensor fixing plate 5, and a sensor fixing base 7 configured to be placed on a working platform surface for the food processor. The machine 1 may include a display screen 11 and a stainless steel cup 12 placed in a recess in a main body of the machine 1, where the stainless steel cup 12 is configured to contain food.

Preferably, the weight sensor 6 may be fixedly mounted, at two ends thereof, on the sensor fixing plate 5 by means of welding, snap-fit, screws or the like, and the sensor fixing plate 5 may also be fixedly mounted on the sensor fixing base 7 by means of welding, snap-fit, screws or the like

Strength of the weight sensors 6 should be selected so that they can support the entire weight of the food processor except the electronic scale 2 and should also be able to support additional weight (for example, weight of the heaviest food which may generally be placed in the stainless steel cup 12).

In addition, the electronic scale 2 also includes a wire concealed box 9 for receiving the electronic scale printed circuit board 3. A ground wire 8 is connected to the sensor fixing plate 5 to ground outer shells of the four weight sensors 6 simultaneously, wherein the ground wire 8 may be connected to the electronic scale printed circuit board 3. The wire concealed box 9 and the electronic scale printed circuit board 3 are mounted on the insulating plate 4 together, and then, the assembled insulating plate 4, and the sensor fixing plate 5 and the weight sensors 6 are detachably mounted on the sensor fixing base 7, as shown in FIG. 2.

Furthermore, four rubber feet 10 made of rubber material or the like may be attached to a bottom of the sensor fixing base 7 to provide support for the food processor and damping of impact. As shown in the view enlarged at a ratio of 3:1 in FIG. 3, the weight sensor 6 may be constituted by a half-bridge circuit 13.

In an embodiment, the weight sensors 6 may be made of metal, and the sensor fixing plate 5 may also be made of metal.

In operation, when the outer shells of the four weight sensors 6 are grounded simultaneously by means of the ground wire 8, interference introduced from the machine 1 or from outside can be filtered out through the ground wire 8, so that the electronic scale 2 operates in a more accurate and stable manner.

Further, in the case that the electronic scale 2 and the machine 1 are detachably assembled, when the machine 1 is in operation, the electronic scale 2 may sense the operation of the machine 1 due to rotation of a motor of the machine 1, and may automatically cancel displaying of the display screen 11; and when the machine 1 stops operation, the electronic scale 2 makes the displaying appear automatically.

Still further, when the machine 1 is overturned during operation, the electronic scale 2 will perceive it due to a change in weight, and then transmit a signal to stop all operation of the machine 1, thereby preventing a damage to the machine 1 and protecting the user's safety.

The above-mentioned food processor may further include other necessary components (e.g., electrical connection, manipulation control, etc.) for realizing its functions. These components are well known to persons skilled in the art and thus are omitted herein.

The above description is only used to exemplarily describe the present disclosure, not to limit the present disclosure. it should be pointed out that, for those of ordinary skill in the art, several improvements, modifications, and variations can be made to the present disclosure, but these improvements, modifications and variations should be regarded as falling within the scope of the present disclosure without departing from the spirit of the present disclosure.

1. A food processor, comprising an electronic scale (2) and a machine (1) placed on the electronic scale (2), the electronic scale (2) comprising an electronic scale printed circuit board (3), an insulating plate (4), a sensor fixing plate (5), four weight sensors (6) fixed on the sensor fixing plate (5), and a sensor fixing base (7) configured to be placed on a working platform surface for the food processor, wherein a ground wire (8) is connected to the sensor fixing plate (5) to ground outer shells of the four weight sensors (6) simultaneously, so that interference introduced from the machine (1) or from outside is filtered out through the ground wire (8) when the electronic scale (2) is in operation.

2. The food processor according to claim 1, wherein the machine (1) is detachably mounted on the electronic scale (2), and wherein when the machine (1) is overturned during operation, the electronic scale (2) is configured to sense a change in weight, and transmit a signal to the machine (1), so that the machine (1) stops all operation.

3. The food processor according to claim 1, wherein the machine (1) comprises a display screen (11), wherein when the machine (1) is in operation, the electronic scale (2) is configured to sense the operation of the machine (1) due to rotation of a motor of the machine (1), and automatically cancel displaying of the display screen (11), and wherein when the machine (1) stops operation, the electronic scale (2) is configured to make the displaying appear automatically.

4. The food processor according to claim 1, wherein the four weight sensors (6) are fixedly mounted, at two ends thereof, on the sensor fixing plate (5), and the sensor fixing plate (5) is fixedly mounted on the sensor fixing base (7).

5. The food processor according to claim 1, wherein the weight sensors (6) are made of metal, and the sensor fixing plate (5) is also made of metal.

6. The food processor according to claim 1, wherein the weight sensor (6) comprises a half-bridge circuit (13).

7. The food processor according to claim 1, wherein four rubber feet (10) are connected to a bottom of the sensor fixing base (7).

8. The food processor according to claim 1, wherein the electronic scale (2) comprises a wire concealed box (9), which, together with the electronic scale printed circuit board (3), is mounted on the insulating plate (4).

9. The food processor according to claim 1, wherein the ground wire (8) is connected to the electronic scale printed circuit board (3).

10. The food processor according to claim 1, wherein the machine (1) comprises a stainless steel cup (12) for containing food.

11. A food processor, comprising an electronic scale (2) and a machine (1) detachably mounted on the electronic scale (2), the electronic scale (2) comprising an electronic scale printed circuit board (3), an insulating plate (4), a metal plate (5), a weight sensor (6) fixed on the metal plate (5), and a sensor fixing base (7)configured to fix the weight sensor (6), wherein the electronic scale printed circuit board (3) is mounted on the insulating plate (4), and wherein a ground wire (8) is connected to the metal plate (5) to ground an outer shell of the weight sensor (6).

12. The food processor according to claim 11, wherein when the machine (1) is overturned during operation, the electronic scale (2) is configured to sense a change in weight, and transmit a signal to the machine (1), so that the machine (1) stops all operation.

13. The food processor according to claim 11, wherein the machine (1) comprises a display screen (11), wherein when the machine (1) is in operation, the electronic scale (2) is configured to sense the operation of the machine (1) due to rotation of a motor of the machine (1), and automatically cancel displaying of the display screen (11), and wherein when the machine (1) stops operation, the electronic scale (2) is configured to make the displaying appear automatically.

14. The food processor according to claim 11, wherein the machine (1) comprises a main body and a stainless steel cup (12), the main body includes a display screen (11) and defines a recess, the stainless steel cup (12) is placed in the recess and is configured to contain food, and the machine (1) further comprises a motor.

15. The food processor according to claim 11, wherein the number of the weight sensor (6) is four, and wherein each weight sensor (6) comprises a half-bridge circuit (13).

16. The food processor according to claim 11, wherein the electronic scale (2) comprises a wire concealed box (9), which is configured to receive the electronic scale printed circuit board (3) and is mounted on the insulating plate (4); and wherein the ground wire (8) is connected to the electronic scale printed circuit board (3).

17. A food processor, comprising an electronic scale (2) and a machine (1) detachably mounted on the electronic scale (2), the electronic scale (2) comprising an electronic scale printed circuit board (3), an insulating plate (4), a metal plate (5), four weight sensors (6) each having an outer shell and fixed on the metal plate (5), and a sensor fixing base (7) configured to fix the weight sensors (6), wherein the electronic scale printed circuit board (3) is mounted on the insulating plate (4), and wherein a ground wire (8) is connected to the metal plate (5) to ground the outer shells of the weight sensors (6) simultaneously.

18. The food processor according to claim 17, wherein when the machine (1) is overturned during operation, the electronic scale (2) is configured to sense a change in weight, and transmit a signal to the machine (1), so that the machine (1) stops all operation; and
wherein the machine (1) comprises a display screen (11), wherein when the machine (1) is in operation, the electronic scale (2) is configured to sense the operation of the machine (1) due to rotation of a motor of the machine (1), and automatically cancel displaying of the display screen (11), and wherein when the machine (1) stops operation, the electronic scale (2) is configured to make the displaying appear automatically.

19. The food processor according to claim 17, wherein the machine (1) comprises a main body and a stainless steel cup (12), the main body includes a display screen (11) and defines a recess, the stainless steel cup (12) is placed in the recess and is configured to contain food, and the machine (1) further comprises a motor.

20. The food processor according to claim 17, wherein each weight sensor (6) comprises a half-bridge circuit (13);
wherein the electronic scale (2) comprises a wire concealed box (9), which is configured to receive the electronic scale printed circuit board (3) and is mounted on the insulating plate (4); and
wherein the ground wire (8) is connected to the electronic scale printed circuit board (3).
